(19) United States
(12) Patent Application Publication
(10) Pub. No.: US 2008/0016575 A1
(43) Pub. Date: Jan. 17, 2008

(54) METHOD AND SYSTEM OF AUTO MESSAGE DELETION USING EXPIRATION

(75) Inventors: MICHAEL T. VINCENT, LAKE WORTH, FL (US); DANIEL A. BAUDINO, LAKE WORTH, FL (US); SCOTT D. BERGER, CORAL SPRINGS, FL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/457,684

(22) Filed: Jul. 14, 2006

(51) Int. Cl. H04N 7/16

(52) U.S. Cl. 726/26

(57) ABSTRACT

A method (40) and system (10, 20 or 30) of message handling can include tagging a message with an expiration period that is designated for delivery to a recipient (108) via a server (106), deleting (58) the message from the server after the expiration period if no third party recipient is designated or if the message is a lower priority message, and delivering (52) the message after the expiration period to a third party if a third party recipient (110) is designated. The method can further include sending (46) a notification to a sender that the expiration period has been reached if the message has not been sent and optionally offering an option to the sender to either delete the message from the server or to resend it with a new or no expiration period. Note, the message can be a text message, voice mail or calendar event message.

### FIELD

This invention relates generally to communication systems, and more particularly to a messaging system and method for automatically deleting a message after an expiration period.

### BACKGROUND

Text messaging systems (such as SMS/MMS) do not guarantee a certain quality of service (QoS) or on time delivery. Sometimes text messages are sent with time sensitive information (e.g., “I'll be there in 5 min”; “the plane is delayed 30 min”). Without a certain QoS or on time delivery, those types of emails or messages fail to have an appropriate meaning or could be found confusing (e.g., “Wait for me, I'll be there in 5 minutes” when the SMS arrives 24 hrs later).

Outlook email system does delete emails after certain time. The email is delivered and then deleted on a local machine. If the message still needed to be sent based on importance or sensitivity, Outlook and similar systems do not allow for an alternate recipient to be selected after a time out period.

### SUMMARY

Embodiments in accordance with the present invention can provide an auto message deletion method and system that intelligently accounts for expiration periods and other factors in making a communication system more efficient.

In a first embodiment of the present invention, a method of message handling can include the steps of tagging a message with an expiration period that is designated for delivery to a recipient via a server, deleting the message from the server after the expiration period if no third party recipient is designated or if the message is a lower priority message, and delivering the message after the expiration period to a third party if a third party recipient is designated. The method can further include the steps of sending a notification to a sender of the message that the expiration period has been reached if the message has not been sent and optionally offering an option to the sender to either delete the message from the server or to resend the message with a new expiration period or no expiration period. The method can further include the step of notifying the sender that the message has been deleted from the server or of non-delivery of the message after the expiration period. Note, the message can be a text message, voice mail or calendar event message or a multimedia message. Also, an “in case of emergency” or “ICE” entry in the sender's address book can be used as default when no third party is specifically designated for those messages marked as “Urgent” after expiration. When the message is a higher priority message, the message can be maintained in the server after the expiration period.

In a second embodiment of the present invention, a server in a two way communication system can include a transceiver and a processor coupled to the transceiver. The processor can be programmed to tag a message from a sender with an expiration period that is designated for delivery to a recipient via the server, delete the message from the server after the expiration period if no third party recipient is designated or if the message is a lower priority message, and deliver the message after the expiration period to a third party if a third party recipient is designated. The processor can be further programmed to send a notification to a sender of the message that the expiration period has been reached if the message has not been sent and can further offer an option to the sender to either delete the message from the server or to resend the message with a new expiration period or no expiration period. The processor can be further programmed to notify the sender that the message has been deleted from the server or of non-delivery of the message after the expiration period. Again, the message can be a text message, voice mail or calendar event message. Also, an “in case of emergency” or “ICE” entry in the sender's address book can be used as default when no third party is specifically designated for those messages marked as “Urgent” after expiration. When the message is a higher priority message, the message can be maintained in the server after the expiration period.

In a third embodiment of the present invention, a wireless communication device can include a transceiver and a processor coupled to the transceiver. The processor can be programmed to tag a message from a sender with an expiration period that is designated for delivery to a recipient via a server, designate the message for delivery after the expiration period to a third party recipient and receive notification of deletion of the message from the server after the expiration period if no third party recipient is designated or if the message is a lower priority message. The processor can be further programmed to receive a notification from the server that the expiration period has been reached if the message has not been sent or further programmed to receive an offer from the server to resend the message with a new expiration period or no expiration period or to delete the message from the server. As in the other embodiments, the message can be a text message, voice mail or calendar event message. Also, an “in case of emergency” or “ICE” entry in the sender's address book can be used as default when no third party is specifically designated.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system. The “processor” as described herein can be any suitable component or combination of components, including any suitable hardware or software, that are capable of executing the processes described in relation to the inventive arrangements.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is an illustration of a communication system using auto message deletion in accordance with an embodiment of the present invention.

FIG. 2 is an illustration of another communication system using auto message deletion using a voicemail server in accordance with another embodiment of the present invention.

FIG. 3 is an illustration of another communication system using auto message deletion and forwarding to a third party in accordance with an embodiment of the present invention.

FIG. 4 is a flow chart of a method of handling messages having expiration periods in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

Embodiments herein can be implemented in a wide variety of exemplary ways that can send an expiration period or a timeout or a date expiration with an associated message such as text message, voice message or calendaring entry. The timeout can be an expiration timer that can delete the message from the network or a server when the message is not delivered on time (due to network traffic, out of coverage, or for other reasons). The timeout and time stamps (when a text message was composed or sent, for example) can be added to the message so the network can make an intelligent decision of what option to take, either deliver or delete or forward, dependent on what flags are set.

If the text message or other message is not delivered on time, a server can delete the message. The deletion of the message may or may not be communicated to the sender or user based on options provided and selected by the user. In this manner, a sender can avoid paying for text messages that are not delivered due to provider problems (traffic load, delays, etc).

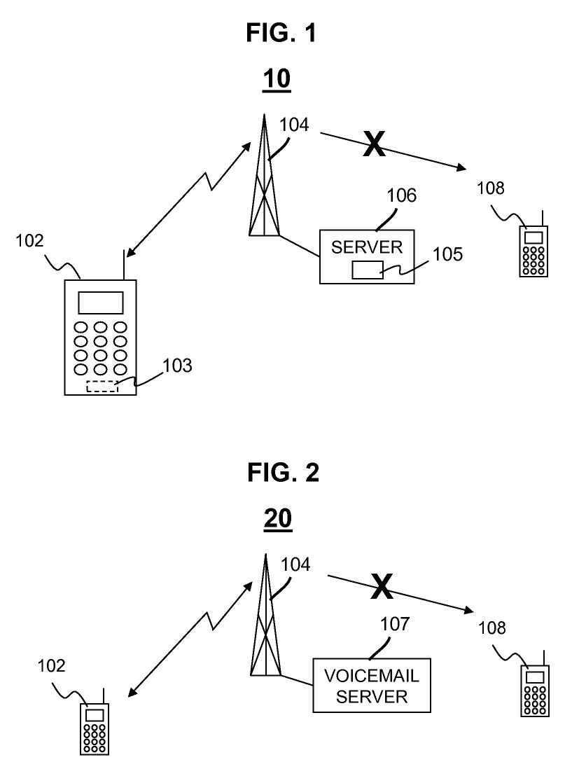

Referring to FIG. 1, a communication system 10 having a first communication device 102 is attempting to send a Short Messaging Service (SMS) message (or any type of text messaging or multimedia) to a second communication device 108 via a server 106 and base station transceiver 104. The communication device 102 can include a processor 103 and the server 106 can also include a processor 105. The first communication device 102 can send a time sensitive text message such as an SMS message or a multimedia message to the second communication device 108 such as “Meet me at the coffee shop in 10 minutes” and further include or apply a 20 minute expiration period to the message. After the user composes a message, he or she can be prompted to enter a timeout or expiration period (configurable) or they can send it directly. The timeout can be added to messages that are time sensitive only. The SMS message can be sent to the network (base station transceiver 104 and/or server 106) with a time stamp. In this scenario, if the network is experiencing heavy traffic and the SMS message is not queued up within 20 minutes for message delivery, the expiration period will lapse or run out and the message will not be delivered to the second communication device 108. In this manner, the network load will be lower since some text messages will be deleted with overdue expiration time when bandwidth is most needed. Note, this can also apply to when the receiving party's communication device (108) is off or under a “No Service” area. If the receiving communication device is off, all the text messages are delivered after the communication device (108) registers to the network (power up). This can be a special case, since it is not the sender's fault that the text message was not delivered. When the network detects that the receiver is not in service, then the network can send a response to the sender (that the text message could not be sent) and the sender might only be charged for the uplink of the text message if at all.

Referring to FIG. 2, the same concept can be applied to Voice Mail that is left on a cellular communication system 20 using a voicemail server 107. After the user is prompted to leave message or hang up, he or she is prompted to leave a time stamp (voice activated or using a numeric keypad); this way if the user does not receive the message before the time out, it is deleted automatically by the network. In this instance, the first communication device 102 can leave a voicemail for intended delivery to the second communication device 108 stating for example “I will be in the library for another 30 minutes if you want to meet me” and further include a 30 minute timeout or expiration period to the voicemail. If the second communication device 108 is in a “no service” state (e.g., out of coverage area or unit is turned off) or if the second communication device 108 fails to acknowledge the pending voicemail within the expiration period, then the network or voicemail server 107 would delete the waiting voicemail and send a notification to the first communication device 102 that the voicemail was deleted.

A similar concept can be applied for calendar appointments. Another flag can be added by the user depending on the importance of the message. Here the importance (a message that “has” to be delivered in a timely manner) can trigger a response back to the sender. If the importance is “low” (or not important), then no response is sent back to the sender when the message delivery fails within the expiration period. If the importance is “mid”, then the sender can receive a text message informing that the message will not be delivered on time. If the user does select to receive confirmation (setting priority mid or higher) of the deletion, he or she may determine at that point in time if the text message is still of value and may select to resend. A message delivered confirmation may also be requested by the sender. If the importance is set to “high” then the user receives a message informing about the delivery failure (e.g., automatic voice message or SMS message).

At this time point, the sender can decide to reach the other end user using another means to reach him or her. This is very useful when the user leaves a critical voicemail, and the other user must respond before a certain time. If the receiver never got the message, then the originator can possibly find an alternative way to reach the receiver.

The importance flag can be associated with another expiration time. Both expiration times can be the same or different (importance flag and message expiration). The use of the importance flag to have a separate timer enables the user to be aware of an undelivered message before the time expires that the user is unreachable using a particular communication system. This gives enough time to the sender to find an alternative.

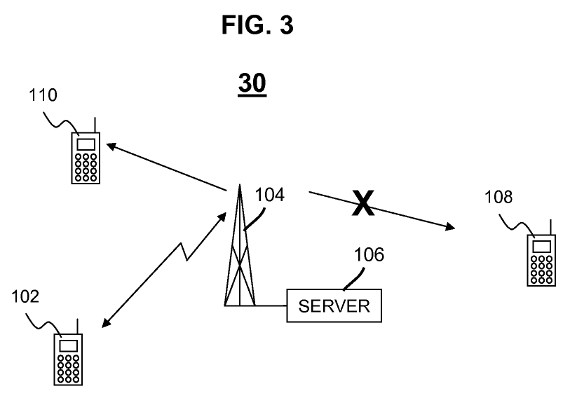

In another embodiment as illustrated by the system 30 of FIG. 3, an originator or sender (102) sends a message to an intended recipient (108) with a tag marked “deliver before this time” (expiration period). The message can also be tagged with an alternate recipient or receiver profile (110), which is particularly useful for emergency or important messages. If the receiver (108) is unavailable or the message was not read during the “deliver before this time” time, then the message can be forwarded to the alternate recipient (110) automatically. As an example, the alternate recipient 110 receives the message if the original intended recipient (108) did not get the message within the intended time interval or before the expiration period. Note, the device 110 can be considered a third party whether the device 110 belongs to a third party or the original intended recipient (108).

The originator or sender can have an “In Case of Emergency” or ICE contact pre-defined on their contact list or with their network provider. In such instances, any messages that are designated by the originator or sender as “emergency or very urgent” can be sent to the ICE contact as a default as the third party alternative if no third party alternative is necessarily designated by the originator. Further, the message can be automatically delivered to the ICE contact when designating “emergency or very urgent” and an expiration period does not necessarily need to be included if marked as very urgent/emergency. A similar technique can be applied to messages that are marked “must be delivered”, so if the receiving party is not available (e.g., out of network coverage), then the message will be delivered to the next contact in the profile (e.g., family profile). For example, a user can call for customer service or support where a response is needed within 30 minutes. If a first customer support personnel for a particular task is not available for 30 minutes, then the message can be forwarded to the next person that is available having such capabilities. This is different from call forwarding in that a recipient might be out of network coverage or temporarily unreachable. In an example of personal and family security, a daughter trying to send a message to her mom would not have messages forwarded using conventional call forwarding when a message is not deliverable due to network coverage. Using the embodiments herein, a message is automatically forwarded to a third party recipient (e.g., her dad) who is listed in the profile of her mom in the event a message is going to be mark expired.

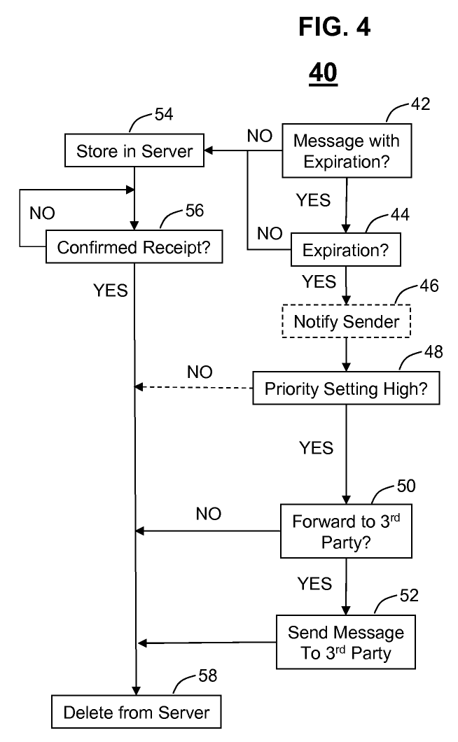

Referring to FIG. 4, a flow chart illustrates a method 40 of message handling. The method can include the step determining if a message is tagged with an expiration period at step 42. If the message has no expiration, then the message can be stored in a server at step 54 until receipt of the message is confirmed at decision block 56 whereupon the message can be deleted from the server at step 58. If the message is tagged with an expiration period at decision block 42, the message can be stored in a server at step 54 until receipt of the message is confirmed at decision block 56 whereupon the message can be deleted from the server at step 58. If the message is tagged with an expiration period and the expiration period has expired at decision block 44, then the sender can be notified at step 46. If the message has a lower priority setting and the expiration period has run out at step 48, the message can also be deleted from the server at step 58. If the message is expired, but the message has a higher priority setting or designated as an emergency and the expiration period is expired at step 48, then the message can be sent to a designated third party at step 52 if it is determined that a third party is designated at decision block 50. The third party is not necessarily limited to actual third parties, but can include any communication device of any suitable entity including a second device that belongs to the original recipient. If there is no third party designation at decision block 50 or the message has already been sent to the third party at step 52, then the message can be deleted at step 58. Note, the message can be a text message, voice mail or calendar event message. Also, an “in case of emergency” or “ICE” entry in the sender's address book can be used as default when no third party is specifically designated. When the message is a higher priority message, the message can be maintained in the server after the expiration period.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of message handling, comprising the steps of:
tagging a message with an expiration period that is designated for delivery to a recipient via a server;
deleting the message from the server after the expiration period if no third party recipient is designated or if the message is a lower priority message; and
delivering the message after the expiration period to a third party if a third party recipient is designated.

2. The method of claim 1, wherein the method further comprises the step of sending a notification to a sender of the message that the expiration period has been reached if the message has not been sent.

3. The method of claim 2, wherein the method further comprises the step of offering an option to the sender to either delete the message from the server or to resend the message with a new expiration period or no expiration period.

4. The method of claim 1, wherein the method further comprises the step of notifying the sender that the message has been deleted from the server or of non-delivery of the message after the expiration period.

5. The method of claim 1, wherein the message is a text message, voice mail or calendar event message.

6. The method of claim 1, wherein the third party is designated as a default to an “in case of emergency” or “ICE” entry in the sender's address book when message is marked “urgent”.

7. The method of claim 1, wherein the message is maintained in the server after the expiration period when the message is a higher priority message.

8. A server in a two way communication system, comprising:
a transceiver; and
a processor coupled to the transceiver, wherein the processor is programmed to:
tag a message from a sender with an expiration period that is designated for delivery to a recipient via the server;
delete the message from the server after the expiration period if no third party recipient is designated or if the message is a lower priority message; and
deliver the message after the expiration period to a third party if a third party recipient is designated.

9. The server of claim 8, wherein the processor is further programmed to send a notification to a sender of the message that the expiration period has been reached if the message has not been sent.

10. The server of claim 9, wherein the server is further programmed to offer an option to the sender to either delete the message from the server or to resend the message with a new expiration period or no expiration period.

11. The server of claim 8, wherein the processor is further programmed to notify the sender that the message has been deleted from the server or of non-delivery of the message after the expiration period.

12. The server of claim 8, wherein the message is a text message, voice mail or calendar event message.

13. The server of claim 8, wherein the third party is designated as a default to an “in case of emergency” or “ICE” entry in the sender's address book.

14. The server of claim 8, wherein the processor is further programmed to maintain the message in the server after the expiration period when the message is a higher priority message.

15. A wireless communication device, comprising:
a transceiver; and
a processor coupled to the transceiver, wherein the processor is programmed to:
tag a message from a sender with an expiration period that is designated for delivery to a recipient via a server;
designate the message for delivery after the expiration period to a third party recipient; and
receive notification of deletion of the message from the server after the expiration period if no third party recipient is designated or if the message is a lower priority message.

16. The wireless communication device of claim 15, wherein the processor is further programmed to receive a notification from the server that the expiration period has been reached if the message has not been sent.

17. The wireless communication device of claim 16, wherein the processor is further programmed to receive an offer from the server to resend the message with a new expiration period or no expiration period or to delete the message from the server.

18. The wireless communication device of claim 15, wherein the message is a text message, voice mail or calendar event message.

19. The wireless communication device of claim 15, wherein the third party is designated as a default to an “in case of emergency” or “ICE” entry in an address book of the wireless communication device.
